(19) United States
(12) Patent Application Publication
(10) Pub. No.: US 2014/0210781 A1
(43) Pub. Date: Jul. 31, 2014

(54) DIGITIZER SYSTEM

(71) Applicant: N-trig Ltd., Kfar-Saba (IL)

(72) Inventor: Yuval STERN, Even-Yehuda (IL)

(73) Assignee: N-trig Ltd., Kfar-Saba (IL)

(21) Appl. No.: 14/164,340

(22) Filed: Jan. 27, 2014

Related U.S. Application Data
(60) Provisional application No. 61/768,561, filed on Feb. 25, 2013.
(60) Provisional application No. 61/757,160, filed on Jan. 27, 2013.

(51) Int. Cl. G06F 3/045

(52) U.S. Cl. CPC G06F 3/045
USPC 345/174

(57) ABSTRACT

A digitizer system includes a sensing surface, a digitizer sensor that senses fingertip or stylus interaction on the sensing surface, digitizer circuitry that operates the digitizer sensor during an active mode of the digitizer circuitry, wherein the digitizer circuitry operates in one of a sleep mode and an active mode and a wake up circuit that operates during the sleep mode of the digitizer circuitry and triggers a switch from the sleep mode to the active mode. A second sensor operated independently from the digitizer sensor, senses fingertip or stylus touch interaction on the sensing surface during the sleep mode of the digitizer circuitry and provides input to the wake up circuit for triggering the digitizer circuitry in response to sensing the fingertip or stylus touch interaction.

### RELATED APPLICATIONS

This application claims the benefit of priority under 35 USC 119(e) of U.S. Provisional Patent Application Nos. 61/757,160 filed Jan. 27, 2013 and 61/768,561 filed Feb. 25, 2013. The contents of the above applications are incorporated herein by reference in their entirety.

### FIELD AND BACKGROUND OF THE INVENTION

The present invention, in some embodiments thereof, relates to a digitizer system and, more particularly, but not exclusively, to a digitizer system including one or more piezoelectric transducers.

Digitizer systems are commonly used as input devices for a variety of Human Interface Devices (HID). Typically, digitizer systems are operated to sense positions of one or more fingers and/or a stylus on a sensing surface and provide coordinates of the positions as input to the HID. Some digitizer systems are integrated with an electronic display screens to provide a touch screen on which a user can select objects displayed on a screen by pointing, perform graphical operations such as creating, moving or otherwise manipulating objects, and/or scroll within a window. Known, touch screens use capacitive based sensors, resistive based sensors, infrared grid sensors or surface acoustic wave sensors to sense positions of interaction, e.g. finger or stylus interaction.

Touch screens are commonly used on mobile devices such as smart phones, Tablet PCs, pen enabled lap-top computers, personal digital assistants (PDAs), or any hand held devices such as digital audio players or video game systems. Typically, the touch screens in mobile devices are used in place of standard keyboards, mice or like to improve mobility. Since mobile devices are typically battery operated, it is typically desired to limit the battery expenditure associated with operation of the touch screen.

U.S. Pat. No. 7,372,455 entitled “Touch Detection for a Digitizer” assigned to N-Trig Ltd., the contents of which is incorporated by reference, describes a detector for detecting touches by fingers or like body parts on a capacitive sensitive sensor. Typically the detector includes a grid of sensing conductors, extending into the sensing surface, a source of electrical energy oscillating at a predetermined frequency, and detection circuitry for detecting a capacitive influence on sensing conductors when an oscillating electrical energy is applied, the capacitive influence being interpreted as a touch. The detector is advantageous in that the same sensing conductors can be used both for touch sensing and for detection of an electromagnetic stylus. U.S. Pat. No. 8,624,878 entitled “Piezo-based acoustic and capacitive detection,” the content of which is incorporated herein by reference, describes an input device for a computing system that includes an input surface, a capacitive sensor associated with the input surface, a piezoelectric sensor and one or more pressure sensors. The capacitive sensor is configured to detect a location of an input on the input surface together with input from the piezoelectric sensor and the pressure sensors. The piezoelectric sensor detects an acoustic signature created from the input and the pressure sensors detect a dampening force applied to the input surface of the input device. The acoustic signature is compared to a database of reference acoustic signatures and to a database of dampened reference acoustic signatures when a dampening force is applied to the input surface to improve location detection of the input.

### SUMMARY OF THE INVENTION

An aspect of some embodiments of the present invention provides for a system and method that wakes up sensing with a digitizer sensor and/or touch screen responsive to output from a piezoelectric sensor and/or transducer embedded in the touch screen. According to some embodiments of the present invention, the system and method also provides for providing tactile feedback and/or audio functions such a speaker and microphone to a user during operation of the touch screen. Optionally, a same piezoelectric transducer is used to both wake up the digitizer system during a sleep mode and to provide feedback in response to input during operation of the digitizer system. In some exemplary embodiments, tactile feedback is provided to improve user experience during operation. An aspect of some embodiments of the present invention provides for a stylus with a piezoelectric transducer for use with the digitizer system. Typically, the piezoelectric transducer in the stylus is used to activate the stylus while the stylus is in sleep mode. Typically, in response to activation, the stylus initiates transmission of a detection signal. Although most of the embodiments of the present invention relate to a piezoelectric sensor fast wake up of the digitizer system and/or stylus, it is noted that other low power sensors that can operate independently of the digitizer sensor can be used in place of the piezoelectric sensor.

An aspect of some embodiments of the present invention provides a digitizer system comprising: a sensing surface; a digitizer sensor that senses fingertip or stylus interaction on the sensing surface; digitizer circuitry that operates the digitizer sensor during an active mode of the digitizer circuitry, wherein the digitizer circuitry operates in one of a sleep mode and an active mode; wake up circuit that operates during the sleep mode of the digitizer circuitry and triggers a switch from the sleep mode to the active mode; and a second sensor that is operated independently from the digitizer sensor, that senses fingertip or stylus touch interaction on the sensing surface during the sleep mode of the digitizer circuitry and provides input to the wake up circuit for triggering the digitizer circuitry in response to sensing the fingertip or stylus touch interaction.

Optionally, the second sensor is any one of an optical sensor, a capacitor displacement sensor and a vibration sensor.

Optionally, the wake up circuit is included in the digitizer circuitry.

Optionally, the digitizer sensor is a grid based capacitive sensor.

Optionally, the digitizer circuitry senses fingertip interaction by a mutual capacitance detection method.

Optionally, the digitizer circuitry alternates between detecting fingertip interaction and detection stylus interaction.

Optionally, the digitizer circuitry does not operate the digitizer sensor in the sleep mode.

Optionally, the digitizer circuitry initiates synchronization in response to wake up by stylus touch interaction.

An aspect of some embodiments of the present invention provides digitizer system comprising: a sensing surface; a digitizer sensor that senses fingertip or stylus interaction on the sensing surface; digitizer circuitry that operates the digitizer sensor during an active mode of the digitizer circuitry, wherein the digitizer circuitry operates in one of a sleep mode and an active mode; wake up circuit that operates during the sleep mode of the digitizer circuitry and triggers a switch from the sleep mode to the active mode; and a piezoelectric transducer that senses fingertip or stylus touch interaction on the sensing surface and provides input to the wake up circuit for triggering the digitizer circuitry in response to sensing the fingertip or stylus touch interaction.

Optionally, the piezoelectric transducer is connected to the sensing surface.

Optionally, the piezoelectric transducer is connected to a frame around the sensing surface.

Optionally, the piezoelectric transducer is formed from a piezo ceramic material or piezo film material.

Optionally, the piezoelectric transducer is electrically connected to the wake up circuit through a switch that alternates between connecting the piezoelectric transducer to an input line of the wake up circuit and an output line of a signal generating circuit.

Optionally, the piezoelectric transducer is connected to an input line of the wake up circuit during the sleep mode and is connected to the output line of a signal generating circuit during the active mode.

Optionally, the signal generating circuit induces the piezoelectric transducer to produce mechanical vibrations.

Optionally, the digitizer system includes a plurality of piezoelectric transducers positioned at locations around a perimeter of the sensing surface.

Optionally, the input provided by the plurality of piezoelectric transducers provides information pertaining to the location of the touch interaction.

Optionally, the plurality of piezoelectric transducers are connected to an output line of a signal generating circuit and wherein signal generating circuit activate the plurality of piezoelectric transducers with defined delays for initiating constructive or destructive wave interference.

Optionally, the piezoelectric transducer provides at least one of speaker and microphone functionality during the active mode of the digitizer system.

Optionally, the wake up circuit is included in the digitizer circuitry.

Optionally, the digitizer sensor is a grid based capacitive sensor.

Optionally, the digitizer circuitry senses fingertip interaction by a mutual capacitance detection method.

Optionally, the digitizer circuitry alternates between detecting fingertip interaction and detection stylus interaction.

Optionally, the digitizer circuitry does not operate the digitizer sensor in the sleep mode.

Optionally, the digitizer circuitry initiates synchronization in response to wake up by stylus touch interaction.

An aspect of some embodiments of the present invention provides for a signal transmitting stylus comprising: stylus circuitry that is operated in one of an active mode during which the stylus transmits a signal and a sleep mode during which no signal is transmitted by the stylus; a wake up circuit that operates during the sleep mode of the stylus and triggers the stylus circuitry to switch from the sleep mode to the active mode; a stylus tip movable in an axial direction from an extended position to a retracted position in response to applied pressure on the stylus tip as when writing; and a piezoelectric transducer that senses tip movement and provides input to the wake up circuit for triggering the stylus circuitry in response to sensing the tip movement.

Optionally, the stylus includes a pressure sensing unit that is only operated during the active mode of the stylus circuitry.

Optionally, the piezoelectric transducer is connected to an output line of a signal generating circuit of the stylus circuitry during the active mode.

Optionally, the signal generating circuit induces the piezoelectric transducer to provide mechanical vibrations.

Optionally, the wake up circuit is included in the stylus circuitry.

An aspect of some embodiments of the present invention includes a method for operating a digitizer system, the method comprising: defining an active mode during which digitizer circuitry operates a digitizer sensor for detecting fingertip or stylus interaction; defining a sleep mode during which operation of the digitizer sensor is on standby and digitizer circuitry operates a wake up circuit that interfaces with a piezoelectric transducer; receiving input from the piezoelectric transducer responsive to a user touching a sensing surface of the digitizer system with a finger or stylus; and switching from a sleep mode to an active mode in response to the piezoelectric transducer sensing touch on a sensing surface of the digitizer sensor.

Optionally, the method comprises inducing the piezoelectric transducer to produce mechanical vibrations during an active mode of the digitizer system.

Optionally, the method comprises including a plurality of piezoelectric transducers to provide mechanical vibrations, the plurality of piezoelectric transducers induced with defined delays for initiating constructive or destructive wave interference.

Optionally, the method comprises reverting back to the sleep mode after a defined period with no sensed fingertip or stylus interaction.

Optionally, the method comprises receiving input from a plurality of piezoelectric transducers positioned around a perimeter of a sensing surface of the digitizer system and determining location of the touch.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified block diagram of an exemplary touch screen computing device in accordance with some embodiments of the present invention;

FIG. 2 is a simplified cross sectional view of an exemplary touch screen computing device in accordance with some embodiments of the present invention;

FIG. 3 is a simplified cross sectional view of an exemplary touch screen computing device including a piezoelectric film in accordance with some embodiments of the present invention;

FIG. 4 is a simplified flow chart of an exemplary method for operating a touch screen computing device in accordance with some embodiments of the present invention;

FIG. 5 is a simplified block diagram of an exemplary touch screen including a plurality or piezoelectric transducers in accordance with some embodiments of the present invention;

FIG. 6 is a simplified flow chart of an exemplary method for operating a piezoelectric transducer in a touch screen computing device in accordance with some embodiments of the present invention;

FIG. 7 is a simplified electrical circuit associated with an exemplary piezoelectric transducer for use with a digitizer sensor in accordance with some embodiments of the present invention; and

FIG. 8 is a simplified schematic drawing of a stylus in accordance with some embodiments of the present invention.

### DESCRIPTION OF SPECIFIC EMBODIMENTS OF THE INVENTION

The present invention, in some embodiments thereof, relates to a digitizer system and, more particularly, but not exclusively, to a digitizer system including one or more piezoelectric transducers.

Typically, electronic devices are designed with energy efficiency in mind. This is particularly the case for mobile devices that are powered with an expendable energy source, e.g. batteries. One known way to improve energy efficiency is to put the system in a low power sleep mode, e.g. maintain some circuits and/or components of a device in a sleep and/or idle mode while not being used instead of maintaining the system in a search mode, and then to wake up the circuits and/or components for detection as required based on input from another lower power component. For example, a digitizer system may be switched into an idle mode responsive to not receiving any user input on the touch screen for an extended period of time and then may be switch to an active mode responsive to sensing a presence of user input. Typically, energy expenditure during an idle mode of the digitizer system is significantly less that during an active period of the digitizer system. Typically it is desired that the switching from idle mode to active mode be seamless and/or instantaneous from a point of view of the user operating the device, so that user experience is not significantly compromised.

The present inventor has found that a response time for waking up a digitizer system can be improved by using a sensor other than the digitizer sensor for sensing and/or determining when to wake up the digitizer system. Optionally, all digitizer circuitry for operating and processing output from a digitizer sensor is shut down during an idle and/or sleep mode of the digitizer system. According to some embodiments of the present invention, a piezoelectric transducer is included in a touch screen device and used for sensing user touching or tapping a touch screen during an idle mode of the digitizer system. The present inventor has found that a piezoelectric transducer can provide a fast response time for waking up the digitizer system and can also be more energy efficient than the digitizer system for detecting renewed interaction of a user with the touch screen. According to some embodiments of the present invention, during an idle mode of the digitizer system, only wakeup circuitry is required to be maintained active while the rest of the components of the digitizer system can be inactive so that they do not consume power.

According to some embodiments of the present invention, the piezoelectric transducer is also used to provide tactile feedback to a user during an active mode of the digitizer system. Typically, the tactile feedback is in response to vibration of the piezoelectric transducer. Optionally, tactile feedback is provided in response to a user touching the touch screen in a particular location, at a particular time and/or in response to a particular event. Optionally, the tactile feedback is provided at the touch location. Typically, the tactile feedback is defined and/or controlled by an application running on the touch screen device. In some exemplary embodiments, the piezoelectric transducer also provides audible feedback. According to some embodiments of the present invention, the piezoelectric transducer is associated with additional components that modulate output from the piezoelectric transducer. Optionally, the device includes more than one piezoelectric transducer and more than one piezoelectric transducer is used for sensing and/or providing feedback.

According to some embodiments of the present invention, a piezoelectric transducer embedded in a signal transmitting stylus is similarly used for waking-up the stylus. According to some embodiments of the present invention, the piezoelectric transducer is used to sense pressure applied on the stylus tip and in response provides input to a controller of the stylus to wake up the stylus to begin transmitting a signal. In some exemplary embodiments, output from the piezoelectric transducer is also used to determine when to switch the stylus into an idle mode, e.g. when to stop transmitting a signal. Optionally, the stylus is switched to an idle mode after a defined period of no activity, e.g. no pressure has been applied on the stylus tip. Optionally, the piezoelectric transducer embedded in the stylus is also used for providing feedback to a user. Optionally, feedback is provided in response to a stylus changing a mode of operation, e.g. changing to an eraser mode or a right click mode.

According to some embodiments of the present invention, a digitizer system initiates a synchronization routine to synchronize itself with a signal transmitting stylus in response to receiving a wake up signal from the piezoelectric transducer embedded in the touch screen device.

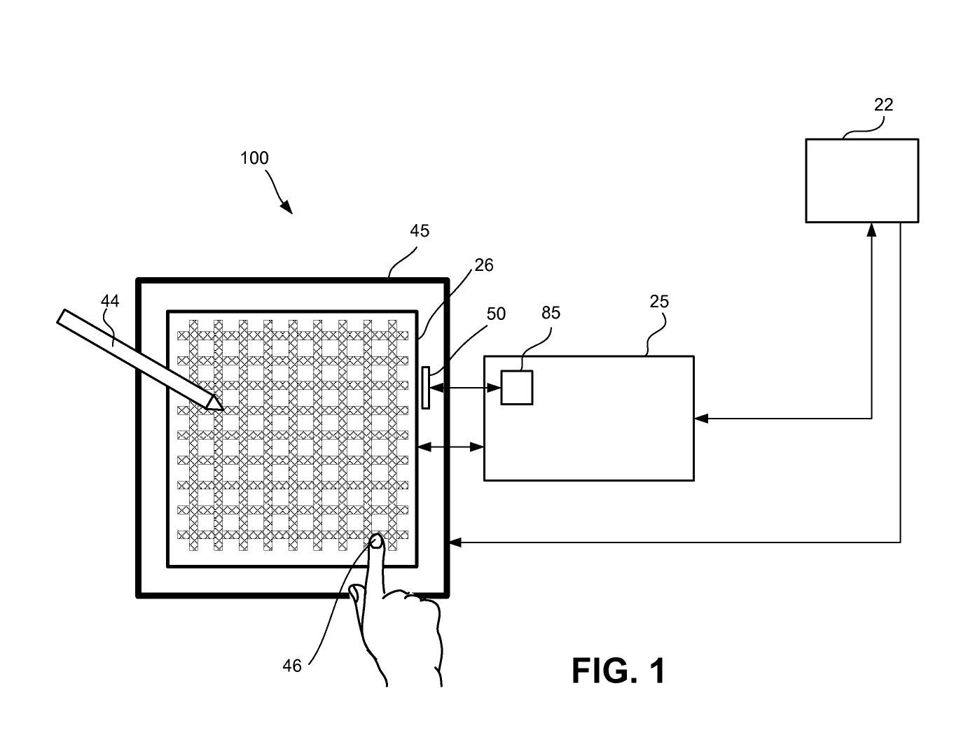

Reference is now made to FIG. 1 showing a simplified block diagram of an exemplary touch screen computing device in accordance with some embodiments of the present invention. According to some embodiments of the present invention, a computing device 100 includes a display screen 45 that is integrated with a digitizer sensor 26 and a piezoelectric transducer 50. Typically, display screen 45, digitizer sensor 26 and piezoelectric transducer 50 together constitute the touch screen of computing device 100. According to some embodiments of the present invention, piezoelectric transducer 50 is operative to sense that a user is touching display screen 45 with a finger 46 or a stylus 44. Optionally, piezoelectric transducer 50 is also used to provide feedback to a user. Typically, piezoelectric transducer 50 is operated to sense touch and/or contact during an idle period of the digitizer sensor 26.

According to some embodiments of the present invention, both digitizer sensor 26 and piezoelectric transducer 50 are operated and/or controlled by circuitry 25. Typically, digitizer sensor 26, piezoelectric transducer 50 and circuitry 25 together constitute a digitizer system. The digitizer system may be suitable for any computing device that enables touch and/or hover input with a body part such as a fingertip and/or dedicated object such as a stylus. Examples of such devices include tablet computers, lap-top computers, personal digital assistant devices, mobile telephones, digital audio players and electronic game devices.

In some exemplary embodiments, digitizer sensor 26 is a grid based capacitive sensor formed from conductive strips that are operative to detect both input by stylus 44 transmitting an electromagnetic signal and/or input by one or more fingertips 46 or other conductive objects. Optionally, a mutual capacitance detection method and/or a self-capacitance detection method are applied for sensing input from fingertip 46. Typically, during mutual capacitance and self-capacitance detection, digitizer circuitry 25 is required to send a triggering pulse and/or interrogation signal to one or more conductive strips of digitizer sensor 26 and to sample output from the conductive strips in response to the triggering and/or interrogation. In some embodiments, some or all of the conductive strips along one axis of the grid based sensor are interrogated in a consecutive manner, and in response to each interrogation, output from the conductive strips on the other axis are sampled. This scanning procedure provides for obtaining output associated with each junction of the grid based sensor 26. Typically, this procedure provides for detecting one or more conductive objects, e.g. fingertip 46 touching and/or hovering over sensor 26 at the same time (multi-touch).

Typically, output from digitizer circuitry 25 is reported to host 22. Typically, the output provided by digitizer circuitry 25 includes coordinates of a stylus 44 and/or coordinates of one or more fingertips 46 interacting with digitizer sensor 26. Optionally, digitizer circuitry 25 additionally reports a hover or touch state for stylus 44 and/or fingertip(s) 46. Optionally, digitizer circuitry 25 additionally identifies coordinates as originating from stylus 44 or fingertip 46. Optionally, digitizer circuitry 25 additionally reports pressure applied on a tip of stylus 44. Typically, digitizer circuitry 25 uses both analog and digital processing to processes signals and/or data picked up from sensor 26. Optionally, some and/or all of the functionality of digitizer circuitry 25 are integrated and/or included in host 22.

Digitizer systems that are similar to digitizer sensor 26 with digitizer circuitry 25 are described with further details, for example in U.S. Pat. No. 6,690,156 entitled “Physical object location apparatus and method and a graphical display device using the same,” U.S. Pat. No. 7,292,229 entitled “Transparent Digitiser,” the contents of the three patents are incorporated herein by reference and/or in incorporated U.S. Pat. No. 7,372,455.

Optionally, digitizer sensor 26 is alternatively an in-cell, on-cell, out-cell, transparent sensor or any other non-capacitive sensor technology, including but not limited to resistive, IR, ultrasonic, optical, or the like.

According to some embodiments of the present invention, digitizer circuitry 25 is operative to enter an idle mode and/or a sleep mode during extended periods over which no user input is provided to the touch screen. Optionally, display screen 45 is operative during an idle mode and/or a sleep mode of the digitizer system. For example, display screen 45 may display a document that a user is reading or display a video for a user to watch. During these periods, a user might not need to interact with the touch screen.

Typically, during the idle mode, operation of digitizer sensor 26 is on standby and digitizer circuitry 25 does not interrogate, sample and/or process output from digitizer sensor 26 and instead piezoelectric transducer 50 is used to sense an onset of renewed user interaction with the touch screen. Typically, the idle mode facilitates reducing the energy expenditure and/or resources required to operate computing device 100 while a user is not interacting with the touch screen.

According to some embodiments of the present invention, a low power wake up circuit 85 that includes an interface with piezoelectric transducer 50 and a trigger unit for activating digitizer circuitry 25 is maintained in standby over the duration of the idle mode of the digitizer system. According to some embodiments of the present invention, wake up circuitry 85 activates digitizer circuitry 25 in response to receiving input from piezoelectric transducer 50 indicating a touch and/or a tap of finger 46, stylus 44 or the like on the touch screen. The present inventor has found that piezoelectric transducer 50 with wake up circuit 85 provides significantly faster wake up with lower power expenditure than would otherwise be provided by periodically sampling output from digitizer sensor 26 to detect renewed interaction. For example in known systems that operate digitizer sensor 26 in a search mode for detecting renewed contact, response time for wake up is a function of a rate that digitizer sensor 26 is interrogated or scanned to detect output. Response time in such systems can be improved by increasing the rate to improve response times but at the expense of increased energy expenditure.

According to some embodiments of the present invention, piezoelectric transducer 50 interfaces with additional elements of digitizer circuitry 25 and/or with host 22 and provides additional functions during an active mode of digitizer circuitry 25.

It will be appreciated that since piezoelectric transducer 50 is typically a passive component that does not require external excitation, the interface with wake up circuit 85 consumes low power. In some exemplary embodiments, the power consumption is between about 1 and about 5 uW. On the other hand, when touch is detected by the digitizer sensor, piezoelectric transducer 50 may receive a signal from circuitry 25, and generate a vibration, thus providing haptic feedback to a user of the device.

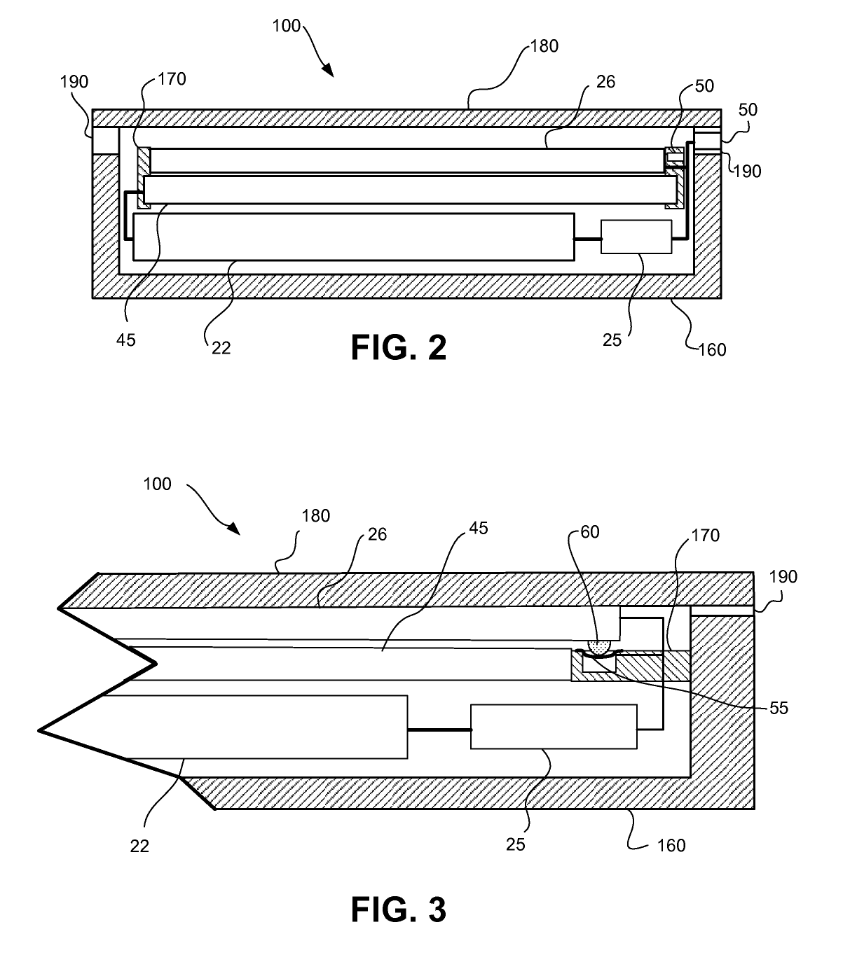

Reference is now made to FIG. 2 showing a simplified cross sectional view of an exemplary touch screen computing device in accordance with some embodiments of the present invention. According to some embodiments of the present invention, computing device has a layered structure including a protective cover 180, digitizer sensor 26 positioned between protective cover 180 and display screen 45, and circuitry including circuitry of host computer 22 and digitizer circuitry 25. Optionally, protective cover 180 is formed from glass and display screen 45 is a flat liquid crystal flat panel display screen or the like. Optionally, digitizer sensor 26 is also formed on a glass substrate. Optionally, one or more of the layers are held in place with a frame 170 and/or connected using adhesive material that is transparent. Optionally, an air gap is provided between layers. Optionally, one or more of the layers are integrated into a single unit, e.g. digitizer sensor may be patterned on protective cover 180. Typically, elements of computing device 100 are housed in housing 160 and protective cover 180 is connected to housing 160 with adhesive material 190. Typically, digitizer sensor 26 is rigid and/or fixed to a rigid surface.

According to some embodiments of the present invention, one or more piezoelectric transducers 50 are positioned between protective cover 180 and housing 160. Alternatively and/or additionally, one or more piezoelectric transducers 50 are connected between a rigid part of sensor 26, e.g. frame 170 and housing 160. Typically, the piezoelectric transducer 50 is connected to a rigid structure of the touch screen so that contact on the touch screen can be detected by piezoelectric transducer 50, e.g. vibrations or a pulse due to contact can be transferred to piezoelectric transducer 50. Optionally, piezoelectric transducer 50 is a ceramic piezoelectric element. In some exemplary embodiments, piezoelectric transducer 50 is coated and/or matched with material that enhances the piezoelectric response of piezoelectric transducer 50 to a user touching or tapping on protective layer 180. In some exemplary embodiments, piezoelectric transducer 50 is coated with material having low elasticity. Optionally, the material for coating is selected to dump certain frequencies and thereby define a resonance frequency or working bandwidth of piezoelectric transducer 50. According to some embodiments of the present invention, electrical output provided by piezoelectric transducer 50 is detected by circuitry 25, e.g. a wake up circuit included in circuitry 25. Optionally, output above a defined threshold is used to wake up the digitizer system from an idle mode.

Reference is now made to FIG. 3 showing a simplified block diagram of an exemplary touch screen computing device including a piezoelectric film in accordance with some embodiments of the present invention. According to some embodiments of the present invention a piezoelectric film transducer 55 is used for sensing a touch and/or tapping force applied on protective layer 180. In some exemplary embodiments, piezoelectric film 55 is embedded in a hole through bezel or frame 170.

Optionally, piezoelectric film 55 is preloaded with a protrusion 60 extending from sensor 26. Optionally, preloading piezoelectric film 55 improves sensitivity of piezoelectric film 55. Optionally, pressure applied on protective cover 180 induces vibrations on and/or bending of sensor 26 and protrusion 60 increases pressure and/or strain on piezoelectric film 55 in response to bending or vibrations.

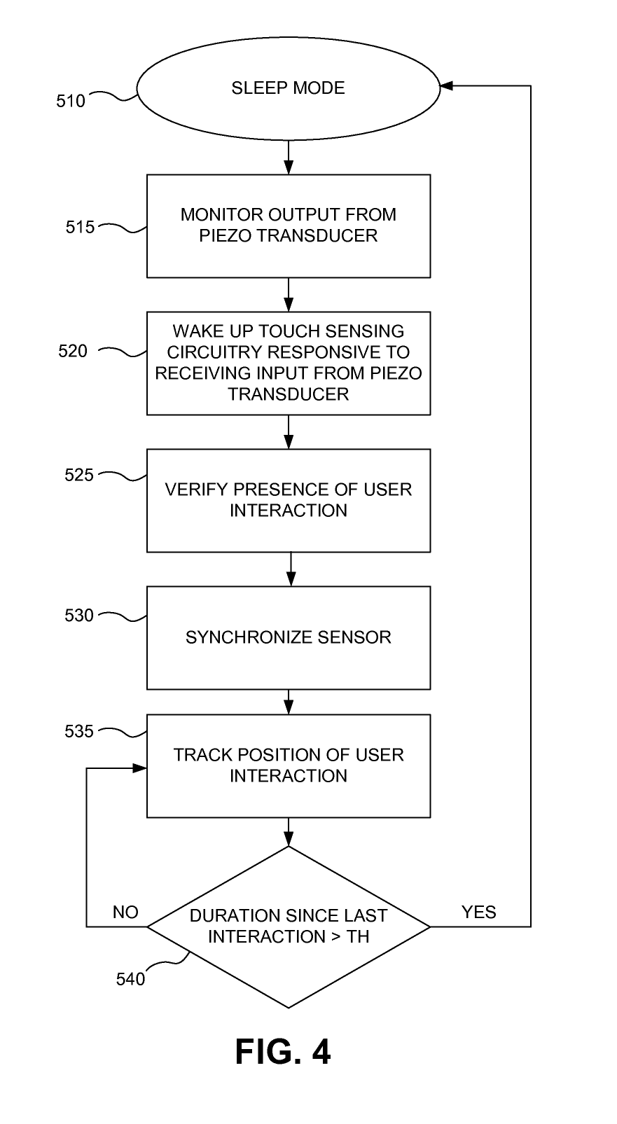

Reference is now made to FIG. 4 showing a simplified flow chart of an exemplary method for operating a touch screen computing device in accordance with some embodiments of the present invention. According to some embodiments of the present invention, while a digitizer system is in a sleep mode (block 510), touch sensing circuitry associated with the digitizer system is deactivated. During this period, output from a piezoelectric transducers, e.g. ceramic or film transducers, positioned on or integrated with the touch screen of a computing device is monitored (block 515). According to some embodiments of the present invention, when output from the piezoelectric transducers is above a defined level, touch sensing circuitry of the digitizer system is activated (block 520). According to some embodiments of the present invention, wake up prompts the digitizer system to operate in a verification and/or search mode to verify that a user interaction such as a stylus or finger is present (block 520). Optionally, if a user interaction is not identified, digitizer system reverts back to sleep mode. Optionally, if a user interaction is identified and the user interaction identified is a signal transmitting stylus, the digitizer system is prompted to synchronize with the stylus signal (block 530). According to some embodiments of the present invention, once the user interaction is verified, the digitizer system begins a tracking mode in which position of the user interaction is tracked (block 535).

Typically, tracking mode is maintained over a duration in which the user interaction (or more than one user interaction) is detected. According to some embodiments of the present invention, after a defined period in which no interaction with the digitizer sensor is detected, touch sensing circuitry is deactivated and/or switched to a sleep mode (block 540).

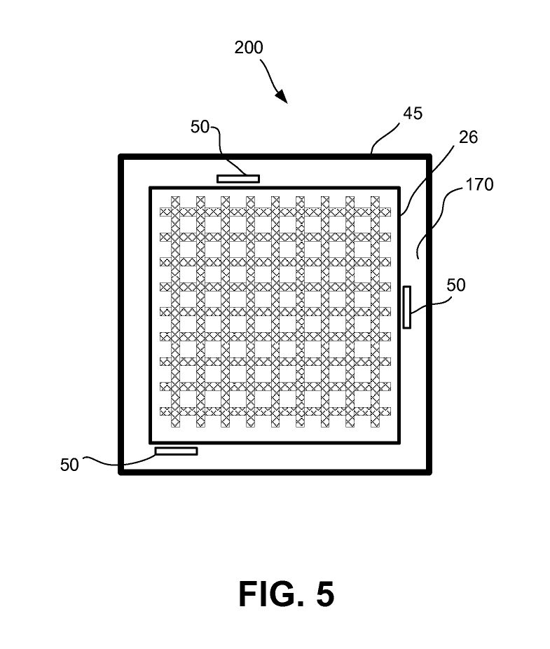

Reference is now made to FIG. 5 showing a simplified block diagram of an exemplary touch screen including a plurality or piezoelectric transducers in accordance with some embodiments of the present invention. According to some embodiments of the present invention, a touch screen 200 includes a plurality of piezoelectric transducers 50 that are spaced apart and positioned around digitizer sensor 26. Optionally, piezoelectric transducers 50 are connected to a frame 170 around digitizer sensor 26. In some exemplary embodiments, one or more of piezoelectric transducers 50 senses touching or tapping on touch screen 200. Typically, the number of piezoelectric transducers 50 effected by a touch or tap depends on the location of the touch or tap and the force applied. Optionally, a location at which touch sensor 200 was touched or tapped is determined based on amplitude and timing of signals from each of the plurality of piezoelectric transducers 50.

In some exemplary embodiments, piezoelectric transducers 50 are controlled to provide feedback to a user, e.g. haptic feedback or tactile feedback at a particular location on touch screen 200. Optionally, digitizer circuitry 25 is operative to sense relative phase of output from a plurality of piezoelectric transducers 50 during touch and provide input to the plurality of piezoelectric transducers 50 with same phase shift for initiating a desired constructive and/or destructive wave interference that will provide feedback, e.g. vibrations at the particular location.

Optionally, piezoelectric transducers 50 are operated in an audible range, e.g. between a few Hz and 20 KHz, so that a desired sound is created, thus providing speaker functionality. Optionally, piezoelectric transducers 50 are used to provide microphone functionality when picking up pressure waves due to sounds in the vicinity of piezoelectric transducers 50.

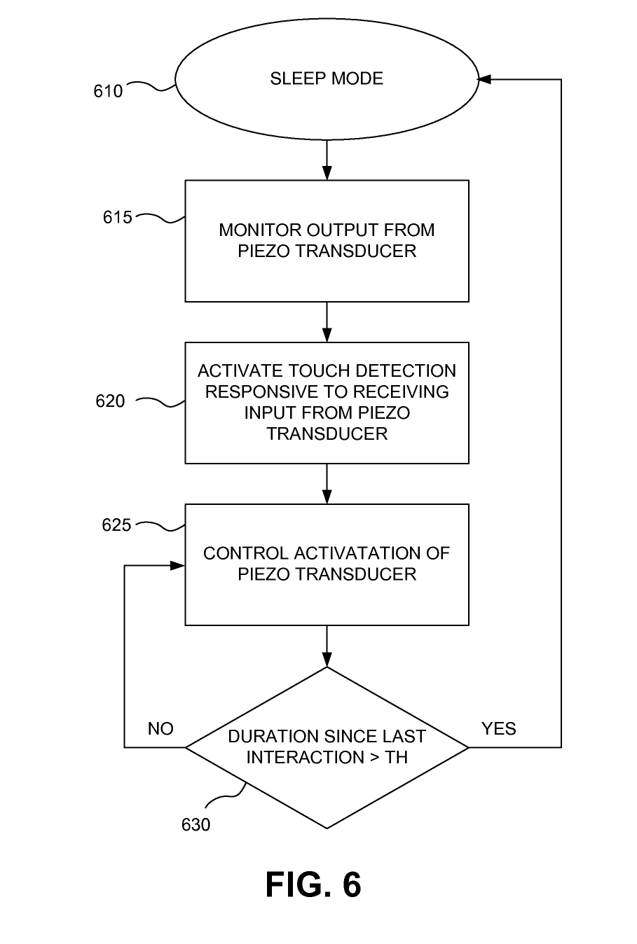

Reference is now made to FIG. 6 showing a simplified flow chart of an exemplary method for operating a piezoelectric transducer in a touch screen computing device in accordance with some embodiments of the present invention. According to some embodiments of the present invention, while a digitizer system is in a sleep mode (block 610), touch sensing circuitry associated with the digitizer system is deactivated. During this period, output from piezoelectric transducers, e.g. ceramic or film transducers, positioned on or integrated with the touch screen of a computing device is monitored (block 615). According to some embodiments of the present invention, when output from the piezoelectric transducers is above a defined level, touch sensing circuitry of the digitizer system is activated and a user input to the touch screen is tracked (block 620). According to some embodiments of the present invention, during an active state of the digitizer system, one or more piezoelectric transducers are activated to provide feedback to the user (block 625). Optionally, the feedback is haptic, tactile and/or audio. Optionally, piezoelectric transducers are operated to provide microphone or speaker functionality. According to some embodiments of the present invention, after a defined period in which no interaction with the digitizer sensor is detected, touch sensing circuitry is deactivated and/or switched to a sleep mode (block 630). According to some embodiments of the present invention, when touch sensing circuitry is deactivated, operation of piezoelectric transducers is switched back to a sensing mode for sensing renewed touch input to the touch screen.

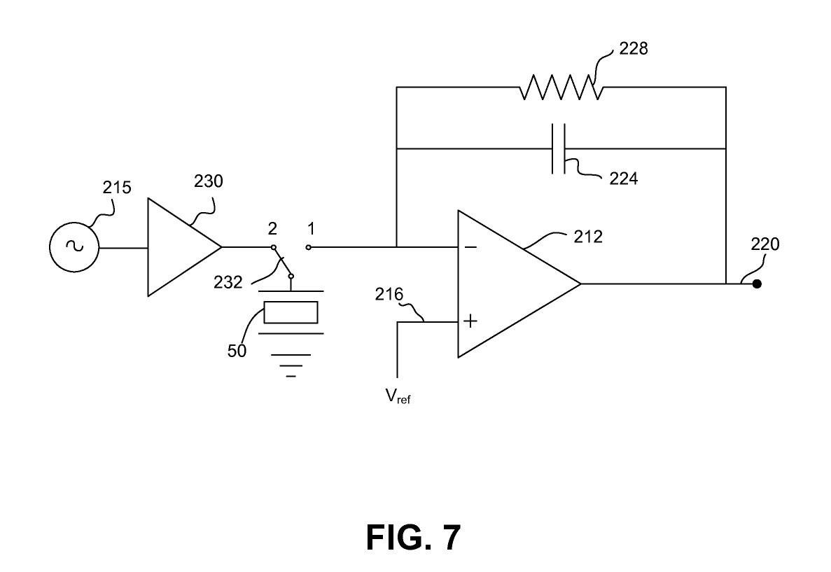

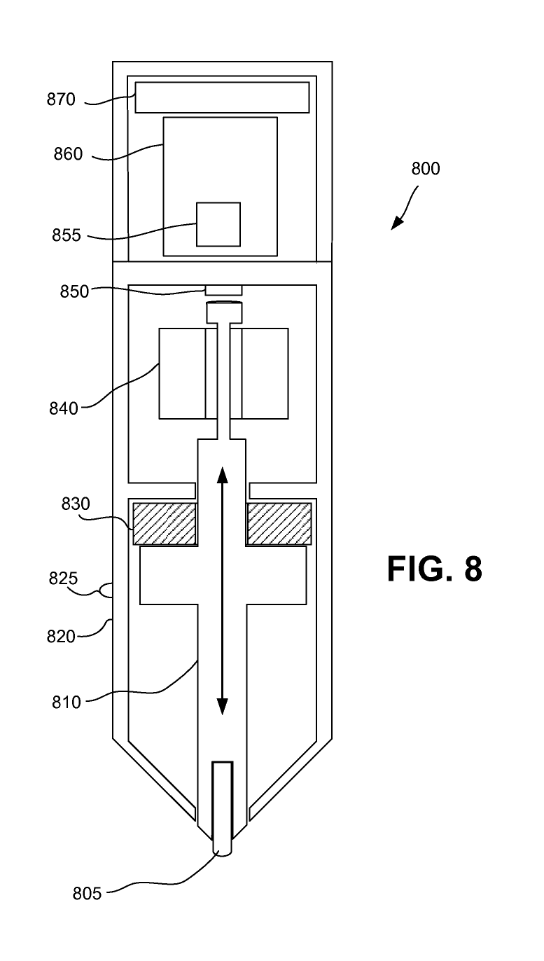

Reference is now made FIG. 7 showing a simplified electrical circuit associated with an exemplary piezoelectric transducer for use with a digitizer sensor in accordance with some embodiments of the present invention. According to some embodiments of the present invention, during a sleep mode of a digitizer system, piezoelectric transducer 50 is connected on one pole to ground and on the other pole to charge amplifier 212, receiving a reference voltage 216. According to some embodiments of the present invention, reference voltage 216 sets the threshold for triggering a wake up circuit connected to output 220. Optionally, a capacitor 224 and a resistor 228 connected in parallel to charge amplifier 212 provides for filtering accidental spikes.

Optionally, connection with charge amplifier 212 is via a switch 232 that switches functionality of piezoelectric transducer 50 from state 1 where piezoelectric transducer 50 functions to provide output in response to sensing mechanical stress to state 2 where piezoelectric transducer 50 functions to provide mechanical vibrations in response to input received from a circuit and/or signal generator. According to some embodiments of the present invention, when switch 232 is in state 2, piezoelectric transducer 50 is connected on one pole to ground and on the other pole to an output of amplifier 230. Optionally, a signal generator 215 generates a signal that is amplified by amplifier 230 for exciting piezoelectric transducer 50.

Reference is now made to FIG. 8 showing a simplified schematic drawing of a stylus in accordance with some embodiments of the present invention. According to some embodiments of the present invention, a stylus 800 is operative to transmit a signal that can be picked up by a digitizer system. Optionally, stylus 800 is also operative to sense pressure applied on its tip 805 and transmit information relating to detected pressure. Optionally, stylus 800 includes one or more buttons 825 on housing 820 that a user can select for controlling output of stylus 800. Optionally, stylus 800 is also operative to transmit information related to button selection. Typically, operation of the stylus 800 is controlled by circuitry 860 and powered by one or more batteries 870. According to some embodiments of the present invention, circuitry 860 is maintained in a sleep mode while stylus 800 not being used and activated in response to sensing pressure applied on a stylus tip as when a user writes with the stylus tip and/or taps stylus tip on a hard surface. Alternatively, activity can be detected with a vibration sensor or capacitive sensor that feels the human hand that holds the pen. Optionally, during a sleep mode, signals are not transmitted from the stylus and circuitry 860 is deactivated.

In some exemplary embodiments, stylus 800 is pressure sensitive and pressure is detected based on displacement of tip 805. Typically, as tip 805 recedes toward housing 820 due to applied pressure, an elastomer element 830 is compressed and the pressure applied on tip 805 is counterbalanced by resilient force applied an elastomer element 830. In some exemplary embodiments, stylus 800 includes an optical displacement sensor 840 or any other sensor that tracks displacement of tip holder 810 during operation of stylus 800. Typically output from optical displacement sensor 840 is detected by circuitry 860. Optionally, optical displacement sensor 840 is operative to differentiate between a hover operational mode when little or no pressure is applied on tip 805 and a touch operational mode when at least a threshold amount of pressure is applied on tip 805. Optionally, circuitry 860 transmits information to indicate one of a hover and touch operational mode as detected by stylus 800 is reported to a digitizer system.

According to some embodiments of the present invention, stylus 800 additionally includes a piezoelectric transducer 850 that is operated during a sleep mode of stylus 800 and used to provide input for activating circuitry 860. In some exemplary embodiments, a user is required to tap on stylus 800 and/or begin writing with stylus 800 to initiate activation of circuitry 860. According to some embodiments of the present invention, when user taps on stylus 800 and/or begins writing with stylus 800 tip 805 and tip holder 810 is displaced and hits piezoelectric transducer 850. Typically, the mechanical stress applied on piezoelectric transducer 850 produces a signal for triggering wake up circuit 855. Typically, the pressure applied by the user is required to be strong enough so that tip holder 810 is displaced to an extent that it engages piezoelectric transducer 850. In some exemplary embodiments, both signal transmission and pressure detection is deactivated during a sleep mode of stylus 800. Optionally, after a pre-defined time period with no activity, e.g. pressure applied on tip 805, stylus 800 enters sleep mode. Optionally, output from optical displacement sensor 840 is used to determine when to initiate a sleep mode. Alternatively and/or additionally, output from piezoelectric transducer is used to determine when to initiate a sleep mode.

In some exemplary embodiments, piezoelectric transducer 850 is additionally operative to provide feedback to a user during an active period of circuitry 860. Optionally, circuitry 860 triggers operation of piezoelectric transducer with a signal to provide feedback. Optionally, stylus 800 includes more than one piezoelectric transducer 850. Optionally, piezoelectric transducer 850 is operated to provide one or more of the functionalities discussed herein above in reference to piezoelectric transducer 50.

According to some embodiments of the present invention, when tapping of stylus 800 on a touch screen while the digitizer system of the touch screen is in sleep mode, the digitizer system and/or wake up circuitry of the digitizer system initiates a synchronization routine for synchronizing the digitizer system with the signal transmitted by stylus 800. Optionally, stylus 800 is operative to transmit a synchronization signal at the onset of activation of the stylus for facilitating the synchronization.

In some embodiments stylus 800 comprises receiving components and/or circuitry for receiving control signals, data signals, synchronization signals or energy from the digitizer system.

The term “consisting essentially of” means that the composition, method or structure may include additional ingredients, steps and/or parts, but only if the additional ingredients, steps and/or parts do not materially alter the basic and novel characteristics of the claimed composition, method or structure.

In is again noted that although most of the embodiments of the present invention relate to a piezoelectric sensor fast wake up of the digitizer system and/or stylus, sensors that can operate independently of the digitizer sensor can be used in place of the piezoelectric sensor. In some exemplary embodiments, an optical sensor is used. Optionally, the optical sensor provides for detecting when a user breaks one or more lines of sight between optical emitters positioned near one edge of the touch screen and optical detectors positioned near an opposite edge of the touch screen. In some exemplary embodiments, a vibration sensor such as an accelerometer is used to detect vibration due to a touch or tap on the touch screen. In some exemplary embodiments, a capacitor displacement sensor is used to detect displacement between two plates of a capacitor due to a touch or tap on the touch screen.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

What is claimed is:

1. A digitizer system comprising:
a sensing surface;
a digitizer sensor that senses fingertip or stylus interaction on the sensing surface;
digitizer circuitry that operates the digitizer sensor during an active mode of the digitizer circuitry, wherein the digitizer circuitry operates in one of a sleep mode and an active mode;
wake up circuit that operates during the sleep mode of the digitizer circuitry and triggers a switch from the sleep mode to the active mode; and
a second sensor that is operated independently from the digitizer sensor, that senses fingertip or stylus touch interaction on the sensing surface during the sleep mode of the digitizer circuitry and provides input to the wake up circuit for triggering the digitizer circuitry in response to sensing the fingertip or stylus touch interaction.

2. The digitizer system according to claim 1, wherein the second sensor is any one of an optical sensor, a capacitor displacement sensor and a vibration sensor.

3. The digitizer system according to claim 1, wherein the digitizer sensor is a grid based capacitive sensor that senses fingertip interaction by a mutual capacitance detection method.

4. A digitizer system comprising:
a sensing surface;
a digitizer sensor that senses fingertip or stylus interaction on the sensing surface;
digitizer circuitry that operates the digitizer sensor during an active mode of the digitizer circuitry, wherein the digitizer circuitry operates in one of a sleep mode and an active mode;
wake up circuit that operates during the sleep mode of the digitizer circuitry and triggers a switch from the sleep mode to the active mode; and
a piezoelectric transducer that senses fingertip or stylus touch interaction on the sensing surface and provides input to the wake up circuit for triggering the digitizer circuitry in response to sensing the fingertip or stylus touch interaction.

5. The digitizer system according to claim 4, wherein the piezoelectric transducer is connected to at least one of the sensing surface and a frame around the sensing surface.

6. The digitizer system according to claim 4, wherein the piezoelectric transducer is formed from a piezo ceramic material or piezo film material.

7. The digitizer system according to claim 4, wherein the piezoelectric transducer is electrically connected to the wake up circuit through a switch that alternates between connecting the piezoelectric transducer to an input line of the wake up circuit and an output line of a signal generating circuit.

8. The digitizer system according to claim 7, wherein the piezoelectric transducer is connected to an input line of the wake up circuit during the sleep mode and is connected to the output line of a signal generating circuit during the active mode and wherein the signal generating circuit induces the piezoelectric transducer to produce mechanical vibrations.

9. The digitizer system according to claim 4, comprising a plurality of piezoelectric transducers positioned at locations around a perimeter of the sensing surface.

10. The digitizer system according to claim 9, wherein the plurality of piezoelectric transducers are connected to an output line of a signal generating circuit and wherein signal generating circuit activate the plurality of piezoelectric transducers with defined delays for initiating constructive or destructive wave interference.

11. The digitizer system according to claim 4, wherein the piezoelectric transducer provides at least one of speaker and microphone functionality during the active mode of the digitizer system.

12. The digitizer system according to claim 4, wherein the wake up circuit is included in the digitizer circuitry.

13. The digitizer system according to claim 4, wherein the digitizer sensor is a grid based capacitive sensor senses fingertip interaction by a mutual capacitance detection method.

14. The digitizer system according to claim 4, wherein the digitizer circuitry does not operate the digitizer sensor in the sleep mode.

15. The digitizer system according to claim 4, wherein the digitizer circuitry initiates synchronization in response to wake up by stylus touch interaction.

16. A method for operating a digitizer system, the method comprising:
defining an active mode during which digitizer circuitry operates a digitizer sensor for detecting fingertip or stylus interaction;
defining a sleep mode during which operation of the digitizer sensor is on standby and digitizer circuitry operates a wake up circuit that interfaces with a piezoelectric transducer;
receiving input from the piezoelectric transducer responsive to a user touching a sensing surface of the digitizer system with a finger or stylus; and
switching from a sleep mode to an active mode in response to the piezoelectric transducer sensing touch on a sensing surface of the digitizer sensor.

17. The method according to claim 16, comprising inducing the piezoelectric transducer to produce mechanical vibrations during an active mode of the digitizer system.

18. The method according to claim 16, comprising inducing a plurality of piezoelectric transducers to provide mechanical vibrations, the plurality of piezoelectric transducers induced with defined delays for initiating constructive or destructive wave interference.

19. The method according to claim 16, comprising reverting back to the sleep mode after a defined period with no sensed fingertip or stylus interaction.

20. The method according to claim 16, comprising receiving input from a plurality of piezoelectric transducers positioned around a perimeter of a sensing surface of the digitizer system and determining location of the touch.
